(19) United States
(12) Patent Application Publication
(10) Pub. No.: US 2020/0084858 A1
(43) Pub. Date: Mar. 12, 2020

(54) Automatic Task Lighting

(71) Applicant: International Business Machines Corporation, Armonk, NY (US)

(72) Inventors: Jana H. Jenkins, Raleigh, NC (US); Jeffrey A. Kusnitz, Campbell, CA (US); John A. Lyons, Ottawa (CA); Ilse Breedvelt-Schouten, Manotick (CA)

(21) Appl. No.: 16/123,067

(22) Filed: Sep. 6, 2018

(51) Int. Cl. H05B 37/02; H05B 33/08; G06K 9/32; G06T 7/13

(52) U.S. Cl. CPC H05B 37/0227; H05B 33/0854; G06K 2209/01; G06K 9/3241; G06T 7/13; H05B 37/0218

(57) ABSTRACT

Mechanisms are provided for automatically providing a user-sensitive amount of light for a specific task. Responsive to detecting an object being lit by a task-lighting device, a set of lighting conditions associated with lighting the object are identified. A first set of parameters is utilized to adjust an amount of light being emitted by a light emitting device of the task-lighting device lighting the object. Responsive to a user manually adjusting the amount of light thereby forming a current amount of light being emitted by the light emitting device, current lighting condition parameters and the current amount of light being emitted by the tight emitting device are identified. The current lighting condition parameters and the current amount of light are then stored as a second set of parameters. The second set of parameters are then utilized for adjusting the amount of light being emitted when changes to the object occurs.

### BACKGROUND

The present application relates generally to an improved data processing apparatus and method and more specifically to mechanisms for automatically providing a user-sensitive amount of light for a specific task.

Lamps, light fixtures, and other lighting devices come in many shapes and sizes. Each of these lighting; devices is provided to accomplish a specific undertaking such as lighting the side of a building or flag, lighting a room or office, or lighting a specific task, commonly referred to as task lighting. Task lighting refers to increasing illuminance to better accomplish a specific activity. However, the illuminance level is not the only factor governing, visibility. Contrast is also important, and a poorly positioned light source may cause contrast reduction, resulting in loss of visibility. The most important purpose of task lighting in the office is not increasing illuminance, but improving contrast. General lighting may be reduced because task lighting provides focused light where needed. Different strategies for task lighting exist. The three, main approaches are:
Localized average lighting, where a lamp supplies both ambient light and task light.
Fred adjustable task light such as a gooseneck, balanced-arm lamp, or swing-arm light.
Asymmetric task light, where the lamp is placed at the side of the work area.

There are also other approaches to task lighting, for example under-shelf luminaires. Other instances of task lighting are in machinery, where a specific work area needs illumination, and in workshops, where a task light may illuminate the actual working area. Special instances of task lighting are examination and operation lights for medicine and surgery, as well as the dentist's lamp. Task lamps are also used for many home tasks such as sewing, reading, small repairs, model construction, crafts, writing, and many other activities. The actual task may range from very small up to about as far as you may reach with your hands or available tools.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for automatically providing a user-sensitive amount of light for a specific task. Responsive to detecting an object being lit by a task-lighting device, the illustrative embodiment identifies a set of lighting conditions associated with lighting the object. The illustrative embodiment utilizes a first set of parameters to adjust an amount of light being emitted by a light emitting device of the task lighting device to light the object. Responsive to a user manually adjusting the amount of light being emitted by the light emitting device thereby forming a current amount of light being emitted by the light emitting device, the illustrative embodiment identifies current lighting condition parameters and the current amount of light being emitted by the light emitting device. The illustrative embodiment stores the current lighting condition parameters and the current amount of light being emitted by the light emitting device as a second set of parameters. The illustrative embodiment utilizes the second set of parameters for adjusting the amount of light being emitted by the light emitting device to light the object when changes to the object occurs,

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 depicts a functional block diagram of a task-lighting device that utilizes a user-sensitive automatic task-lighting mechanism that automatically provides a user-sensitive amount of light for a specific task in accordance with an illustrative embodiment; and

FIG. 4 depicts an exemplary flow diagram of the operation performed by a user-sensitive automatic task-lighting mechanism for automatically providing a user-sensitive amount of light for a specific task in accordance with an illustrative embodiment.

### DETAILED DESCRIPTION

As noted previously, task lighting increasing illuminance and/or contrast to better accomplish a specific activity. While task lighting may provide localized average lighting, freely adjustable task lighting, or asymmetric task lighting, the amount of illuminance and/or contrast provided for a specific task is dependent on the user that is benefiting from the task lighting. Since a user's eyesight changes over the user's lifetime, task lighting for one user may not be the same as task lighting for another user.

Thus, the illustrative embodiments provide a user-sensitive automatic task lighting mechanism for task-lighting devices. The user-sensitive automatic task lighting mechanism detects an object for which task lighting is being utilized and uses feedback, such as luminescence, white-balancing, contrast, or the like, to adjust the amount of light that is being provided by the task-lighting device to light the object. Utilizing a default and/or personalized lighting preferences, the user-sensitive automatic task-lighting mechanism adjusts the lighting behavior provided by the task-lighting device to a comfortable, personalized level to achieve the task being performed by the associated user.

Before beginning the discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a,” “at least one of,” and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

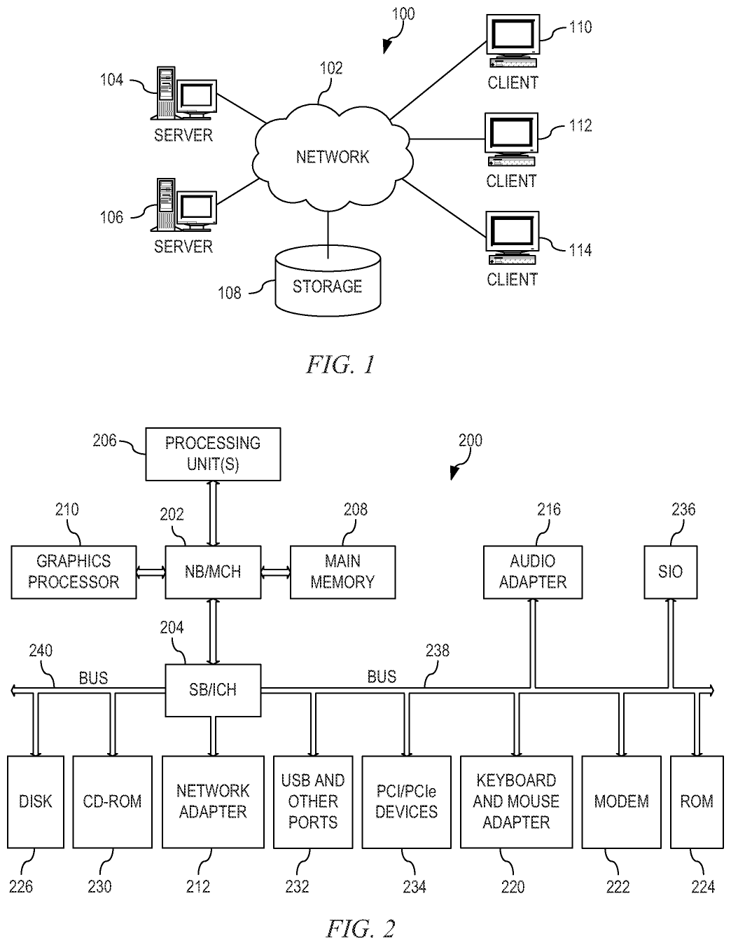

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

As shown in FIG. 1, one or more of the computing devices, e.g., server 104, may be specifically configured to implement a user-sensitive automatic task lighting mechanism. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates a user-sensitive automatic task-lighting mechanism.

As noted above, the mechanisms of the illustrative embodiments utilize specifically configured computing devices, or data processing systems, to perform the operations for automatically lighting an object based on user sensitivity. These computing devices, or data processing systems, may comprise various hardware elements which are specifically configured, either through hardware configuration, software configuration, or a combination of hardware and software configuration, to implement one or more of the systems/subsystems described herein. FIG. 2 is a block diagram of just one example data processing system in which aspects of the illustrative embodiments may be implemented. Data processing system 200 is an example of a computer, such as server 104 in FIG. 1, in which computer usable code or instructions implementing the processes and aspects of the illustrative embodiments of the present invention may be located and/or executed so as to achieve the operation, output, and external effects of the illustrative embodiments as described herein.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM eServer™ System p® computer system, Power™ processor based computer system, or the like, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

As mentioned above, in some illustrative embodiments the mechanisms of the illustrative embodiments may be implemented as application specific hardware, firmware, or the like, application software stored in a storage device, such as HDD 226 and loaded into memory, such as main memory 208, for executed by one or more hardware processors, such as processing unit 206, or the like. As such, the computing device shown in FIG. 2 becomes specifically configured to implement the mechanisms of the illustrative embodiments and specifically configured to perform the operations and generate the outputs described hereafter with regard to user-sensitive automatic task lighting mechanism.

Those of ordinary skill in the art will appreciate that the hardware in FIGS. 1 and 2 may vary depending on the implementation. Other internal hardware or peripheral devices, such as flash memory, equivalent non-volatile memory, Or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

Again, the illustrative embodiments provide a user-sensitive automatic task-lighting mechanism. The user-sensitive automatic task-lighting mechanism utilizes a set of sensors and/or detectors to determine an object that is being lit by the task-lighting device. The set of sensors and/or detectors also detect one or more of a luminescence, white-balancing, contrast, or the like, associated with the object that is being lit. Based on the detected information, the user-sensitive automatic task-lighting mechanism adjusts the lighting being provided by the task-lighting device. That is, the user-sensitive automatic task-lighting mechanism adjusts the light intensity or brightness provided by the task-lighting device to a preferred setting for the user that is using the object and thus, the task-lighting device that is lighting the object Thus, the user-sensitive automatic task-lighting mechanism provides an amount of light that is personalized to the person and/or task involved.

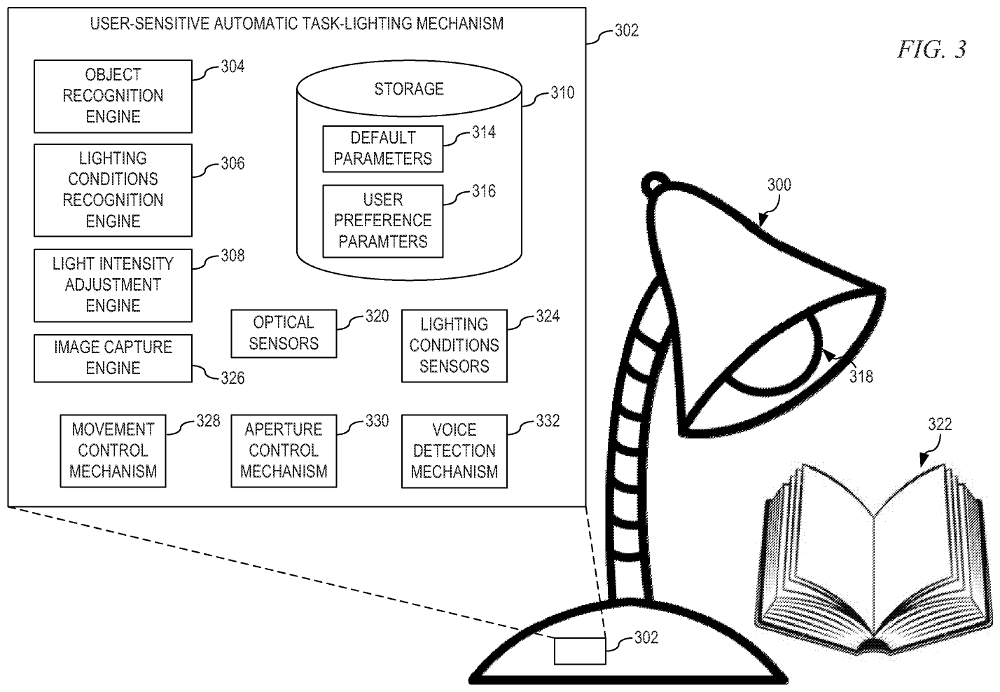

FIG. 3 depicts a functional block diagram of a task-lighting device that utilizes a user-sensitive automatic task-lighting mechanism that automatically provides a user-sensitive amount of light for a specific task in accordance with an illustrative embodiment. Task-lighting device 300, which is a data processing system such as data processing system 100, comprises user-sensitive automatic task-lighting mechanism 302. User-sensitive automatic task-lighting mechanism 302 comprises object recognition engine 304, lighting conditions recognition engine 306, light intensity adjustment engine 308, and storage 310. When light-emitting device 318, i.e. an incandescent light bulb, a dimmable light-emitting diode light bulb, a dimmable florescent light bulb, or the like, of task-lighting device 300 is powered on, in order to automatically providing a user-sensitive amount of light for a specific task, such as reading a book, operating machinery, preparing a meal, or the like, object recognition engine 304 utilizes one or more object recognition sensors 320, such as, for example, an optical sensor, edge detection sensor, gray-scale matching sensor, or the like, to detect object 322 that is being lit by light-emitting device 318 of task-lighting device 300. Object recognition engine 304 may differentiate the object from, for example, a desk or table, by detecting movement of the object that is to be lit by task-lighting device 300. In one embodiment, if no object is detected by object recognition engine 304 in a predetermined amount of time, object recognition engine 304 may signal to light intensity adjustment engine 308 to turn light-emitting device 318 to an off position.

However, if object recognition engine 304 detects that object 322 is present, lighting conditions recognition engine 306 performs a set of operations to determine a light intensity associated with lighting object 322. For example, using lighting condition sensors 324 such as, for example, a luminosity or lux sensor, a contrast detection sensor, a white-balancing detection sensor, optical character recognition sensor, or the like, lighting conditions recognition engine 306 may determine the amount of light that is being displayed on object 322. If a set of user preference parameters 316 is not yet established, light intensity adjustment engine 308 utilizes default parameters 314 to adjust the amount of light being emitted by light-emitting device 318 to a level to achieve the task for which task-lighting device 300 is being utilized.

Once light intensity adjustment engine 308 adjusts the amount of light being emitted by light-emitting device 318, light intensity adjustment engine 308 may determine whether the user manually adjusts the amount of light being emitted by light-emitting device 318 to a user-preferred level. If the user manually adjusts the amount of light being emitted by light-emitting device 318, light intensity adjustment engine 308 stores the current parameters of lighting condition sensors 324 and the amount of light being emitted by light-emitting device 318 as user preference parameters 316. Then the next time light intensity adjustment engine 308 adjusts the amount of light being emitted by light-emitting device 318, light intensity adjustment engine 308 will utilize user preference parameters 316 to adjust the amount of light being emitted by light-emitting device 318. If the user does not make any adjustments to the amount of light being emitted by light-emitting device 318 based on default parameters 314 or after storing the current parameters as user preference parameters 316, object recognition engine 304 continues to detect changes in object 322 that is being lit by light-emitting device 318 of task-lighting device 300.

As a further embodiment, object recognition engine 304 may determine whether object 322 is changing from a first period to a second time period as well as a time interval between the first and second time periods, and facilitate a change in the amount of light being emitted by light-emitting device 318 through light intensity adjustment engine 308 if the interval is longer or shorter than a predetermined time interval threshold. For example, is a user reading a book has been turning pages every 5 minutes, but then next page turn takes 7 minutes, then object recognition engine 304 may send a signal to light intensity adjustment engine 308 to increase the lighting level as the pages may be harder for the user to read. As another example, if a user chopping vegetables was chopping at one speed but then slows down in their chopping, object recognition engine 304 may send a signal to light intensity adjustment engine 308 to increase the lighting level as the surface on which the vegetables are being chopped may be harder for the user to see. While the examples use an increase in the lighting level output by light-emitting device 318, the illustrative embodiment may recognize that a decrease in the lighting level output by light-emitting device 318 may be necessary in other instances without departing from the spirit and scope of the invention.

In order to determine a change in object 322 from a first period to a second time period as well as a time interval between the first and second time periods, object recognition engine 304 may capture a set of images utilizing image capture engine 326, each image having an associated time stamp. Object recognition engine 304 compares images and if there is no movement of the object in a first image as compared to the same object in a second image and the time interval between the time stamp of the first image and the time stamp of the second image is longer or shorter than the predetermined time interval threshold, then object recognition engine 304 signal light intensity adjustment engine 308 to adjust the amount of light being emitted by light-emitting device 318.

In order to exemplify the operations performed by user-sensitive automatic task-lighting mechanism 302, consider the following examples. In a first example, a user is reading a book and utilizes a reading lamp to light the pages of the book. The components of the user-sensitive automatic task-lighting mechanism 302 identify the book as the object for which the reading lamp is being utilized and detect reflected light as a basis for how much extra light is needed. The components of the user-sensitive automatic task-lighting mechanism 302 adjust its intensity of the light being emitted based on where the book is, because a person could change positions while sitting. That is, user-sensitive automatic task-lighting mechanism 302 may be equipped with both movement control mechanism 328 and aperture control mechanism 330. Thus, when a user changes position, such as leaning from a right side of a chair to a left side of a chair, when user-sensitive automatic task-lighting mechanism 302 detects such a movement of the book, movement control mechanism 328 repositions task-lighting device 300 such that the beam position is adjusted based on whether the book is. Similarly, user may move the book either closer or further away from a starting position. Thus, when user-sensitive automatic task-lighting mechanism 302 detects such a movement of the book, the beam of light emitted by light-emitting device 318 may need to be narrowed or widened. Therefore, aperture control mechanism 330 narrows or widens an aperture of task-lighting device 300 such that the beam of light emitted by light-emitting device 318 is narrowed or widened. Further, if the user puts down the book, then the user-sensitive automatic task-lighting mechanism 302 may turn task-lighting device 300 off or, utilizing voice detection mechanism 332, detect a conversation taking place and change the intensity of the beam of light emitted by light-emitting device 318 to an ambient lighting level to produce enough light to create a social atmosphere.

In another example, a user is looking in a vanity mirror that is surrounded by light bulbs. Since some people are taller than others, since some people stand closer to the mirror than others, and/or since some people's facial color is different than others, user-sensitive automatic task-lighting mechanism 302 may control each light bulb around the mirror at a different level so as to light the object, i.e. the user's face, so that, based on the position of the user's face, top light bulbs may be brighter than the bottom light bulbs in order to make the facial appearance better. In yet another example, a user is preparing a meal but more specifically is using a knife to prepare the vegetables for the meal. In this example, the knife, the vegetables, and the user's hands are the objects of concern. Depending to position of these objects, user-sensitive automatic task-lighting mechanism 302 increases or decreases the emitted light using reflected light on the knife, the vegetables, and the user's hands.

Thus, the user-sensitive automatic task-lighting mechanism 302 utilizes a set of sensors and/or detectors to determine an object that is being lit by the task-lighting device and detects one or more of a luminescence, white-balancing, contrast, or the like, associated with the object that is being lit. Based on the detected information, the user-sensitive automatic task-lighting mechanism 302 adjusts the light intensity or brightness provided by the task-lighting device to a user-preferred setting that is personalized to the person and/or task involved.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart, illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

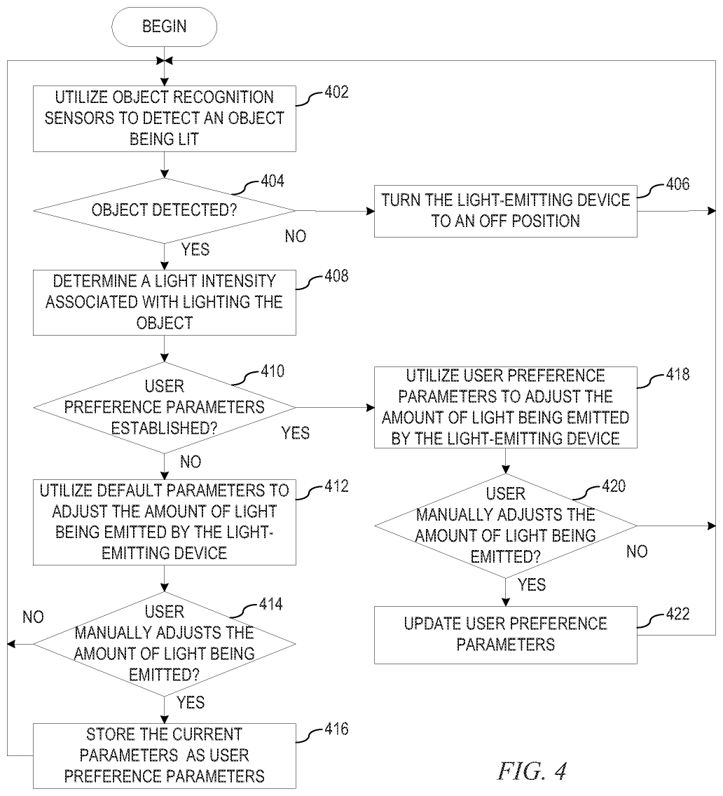

FIG. 4 depicts an exemplary flow diagram of the operation performed by a user-sensitive automatic task-lighting mechanism for automatically providing a user-sensitive amount of light for a specific task in accordance with an illustrative embodiment. As the operation begins, an object recognition engine of the user-sensitive automatic task-lighting mechanism utilizes one or more object recognition sensors, such as, for example, an optical sensor, edge detection sensor, gray-scale matching sensor, or the like, to detect an object that is being lit by a light-emitting device of the task-lighting device (step 402). The object recognition engine may differentiate the object from, for example, a desk or table, by detecting movement of the object that is to be lit by the task-lighting device. Thus, object recognition engine determines whether an object has been detected (step 404). If at step 404 the object recognition engine fails to detect an object, then the object recognition engine signals a light intensity adjustment engine of the user-sensitive automatic task-lighting mechanism to turn the light-emitting device to an off position (step 406) with the operation returning to step 402.

If at step 404 the object recognition engine detects an object, a lighting conditions recognition engine of the user-sensitive automatic task-lighting mechanism performs a set of operations to determine a light intensity associated with lighting the object (step 408). For example, the lighting conditions recognition engine uses a set of lighting condition sensors such as, for example, a luminosity or lux sensor, a contrast detection sensor, a white-balancing detection sensor, optical character recognition sensor, or the like, to determine the amount of light that is being displayed on the object. Once the amount of light that is being displayed on the object is determined, a light intensity adjustment engine of the user-sensitive automatic task-lighting mechanism determines whether a set of user preference parameters has been established (step 410). If at step 410 the set of user preference parameters has not been set, then the light intensity adjustment engine utilizes default parameters to adjust the amount of light being emitted by the light-emitting device to a level to achieve the task for which the task-lighting device is being utilized (step 412).

Once the light intensity adjustment engine adjusts the amount of light being emitted by the light-emitting device using the default parameters, the light intensity adjustment engine determines whether the user manually adjusts the amount of light being emitted by the light-emitting device to a user-preferred level (step 414). If at step 414 the user manually adjusts the amount of light being emitted by the light-emitting device, the light intensity adjustment engine stores the current parameters of the lighting condition sensors and the amount of light being emitted by light-emitting device as user preference parameters (step 416), with the operation returning to step 402 thereafter. If at step 414 the user manually fails to adjust, the amount of light being emitted by the light-emitting device, the operation returns to step 402.

If at step 410 the set of user preference parameters have been set, then the light intensity adjustment engine utilizes the user preference parameters to adjust the amount of light being emitted by the light-emitting device to a level to achieve the task for which the task-lighting device is being utilized (step 418). Once the light intensity adjustment engine adjusts the amount of light being emitted by the light-emitting device using the user preference parameters, the light intensity adjustment engine determines whether the user manually adjusts the amount of light being emitted by the light-emitting device to a user-preferred level (step 420). If at step 420 the user manually adjusts the amount of light being emitted by the light-emitting device, the light intensity adjustment engine utilizes the current parameters of the lighting condition sensors and the amount of light being emitted by light-emitting device to update the user preference parameters (step 422), with the operation returning to step 402 thereafter. If at step 420 the user manually fails to adjust the amount of light being emitted by the light-emitting device, the operation returns to step 402.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or early out combinations of special purpose hardware and computer instructions.

Thus, the illustrative embodiments provide mechanisms for automatically providing a user-sensitive amount of light for a specific task. The user-sensitive automatic task lighting mechanism detects an object for which task lighting is being utilized and uses feedback, such as luminescence, white-balancing, contrast, or the like, to adjust the amount of light that is being provided by the task-lighting device to light the object. Utilizing a default and/or personalized lighting preferences, the user-sensitive automatic task-lighting mechanism adjusts the lighting behavior provided by the task-lighting device to a comfortable, personalized level to achieve the task being performed by the associated user.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least sonic program code in order to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless I/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable moderns and Ethernet cards are just a few of the currently available types of network adapters for wired communications. Wireless communication based network adapters may also be utilized including, but not limited to, 802.11 a/b/g/n wireless communication adapters, Bluetooth wireless adapters, and the like. Any known or later developed network adapters are intended to be within the spirit and scope of the present invention.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

1. A method, in a data processing system, for automatically providing a user-sensitive amount of light for a specific task, the method comprising:
detecting an object being lit by a task-lighting device utilizing a set of object recognition sensors comprising an optical sensor, an edge detection sensor, and gray-scale matching sensor;
responsive to detecting the object being lit by the task-lighting device, identifying a set of lighting conditions associated with lighting the object utilizing a set of lighting condition sensors, the set of lighting condition sensors comprising a luminosity or lux sensor, a contrast detection sensor, a white-balancing detection sensor, and an optical character recognition sensor;
utilizing a first set of parameters to adjust an amount of light being emitted by a light emitting device of the task lighting device to light the object;
responsive to a user manually adjusting the amount of light being emitted by the light emitting device thereby forming a current amount of light being emitted by the light emitting device, identifying current lighting condition parameters and the current amount of light being emitted by the light emitting device;
storing the current lighting condition parameters and the current amount of light being emitted by the light emitting device as a second set of parameters; and
utilizing the second set of parameters for adjusting the amount of light being emitted by the light emitting device to light the object when changes to the object occurs.

2-3. (canceled)

4. The method of claim 1, further comprising:
responsive to the user manually adjusting the amount of light being emitted by the light emitting device after the second set of parameters have been utilized to adjust the amount of light being emitted by the light emitting device, identifying current lighting condition parameters and the current amount of light being emitted by the light emitting device;
updating the current lighting condition parameters and the current amount of light being emitted by the light emitting device of the second set;of parameters; and
utilizing the second set of parameters to adjust the amount of light being emitted by the light emitting device to light the object when further changes to the object occurs.

5. The method of claim 1, wherein the task-lighting device comprises a plurality of light emitting devices and where each of the light emitting device is controlled individually based on the lighting condition parameters associated with the object and wherein at least one of the light emitting devices is adjusted to output a different amount of light than at least one other of the light emitting devices.

6. The method of claim 1, further comprising:
responsive to a failure to detect a change in the object from a first time period to a second time period, adjusting the amount of light being emitted by the light emitting device to an off level.

7. The method of claim 1, further comprising:
responsive to detecting a, change in the object from a first time period to a second time period, either increasing or decreasing the amount of light being emitted by the light emitting device.

8. A computer program product comprising a computer readable storage medium having a computer readable program stored therein, wherein the computer readable program, when executed on a computing device, causes the computing device to:
detect an object being lit by a task-lighting device utilizing a set of object recognition sensors comprising an optical sensor, an edge detection sensor, and a gray-scale matching sensor.
responsive to detecting the object being lit by the task-lighting device, identify a set of lighting conditions associated with lighting the object utilizing a set of lighting condition sensors, the set of lighting condition sensors comprising a luminosity or lux sensor, a contrast detection sensor, a white-balancing detection sensor, and an optical character recognition sensor;
utilize a first set of parameters to adjust an amount of light being emitted by a light emitting device of the task lighting device to light the object;
responsive to a user manually adjusting the amount of light being emitted by the light emitting, device thereby forming a current amount of light being emitted by the light emitting device, identify current lighting condition parameters and the current amount of light being emitted by the light emitting device;
store the current lighting condition parameters and the current amount of light being emitted by the light emitting device as a second set of parameters; and
utilize the second set of parameters for adjusting the amount of light being emitted by the light emitting device to light the object when changes to the object occurs.

9-10. (canceled)

11. The computer program product of claim 8, wherein the computer readable program further causes the computing device to:
responsive to the user manually adjusting the amount of light being emitted by the light emitting device alter the second set of parameters have been utilized to adjust the amount of light being emitted by the light emitting device, identify current lighting condition parameters and the current amount of light being emitted by the light emitting device;
update the current lighting condition parameters and the current amount of light being emitted by the light emitting device of the second set of parameters; and
utilize the second set of parameters to adjust the amount of light being emitted by the light emitting device to light the object when further changes to the object occurs.

12. The computer program product of claim 8, wherein the task the task-lighting device comprises a plurality of tight emitting devices and where each of the light emitting device is controlled individually based on the lighting condition parameters associated with the object and wherein at least one of the light emitting devices is adjusted to output a different amount of light than at least one other of the light emitting devices.

13. The computer program product of claim 8, wherein the computer readable program further causes the computing device to:
responsive to a failure to detect a change in the object from a first time period to a second time period, adjust the amount of light being emitted by the light emitting device to an off level.

14. The computer program product of claim 8, wherein the computer readable program further causes the computing device to:
responsive to detecting a change in the object from a first time period to a second time period, either increase or decrease the amount of light being emitted by the light emitting device.

15. An apparatus comprising:
a processor; and
a memory coupled to the processor, wherein the memory comprises instructions which, when executed by the processor, cause the processor to:
detect an object being lit by a task-lighting device utilizing a set of object recognition sensors comprising an optical sensor, an edge detection sensor, and a gray-scale matching sensor;
responsive to detecting the object being lit by the task-lighting device, identify a set of lighting conditions associated with lighting the object utilizing a set of lighting condition sensors, the set of lighting condition sensors comprising a luminosity or lux sensor a contrast detection sensor a white-balancing detection sensor, and an optical character recognition sensor;
utilize a first set of parameters to adjust an amount of lieu being emitted by a light emitting device of the task lighting device to light the object;
responsive to a user manually adjusting the amount of light being emitted by the light emitting device thereby forming a current amount of light being emitted by the light emitting device, identify current lighting condition parameters and the current amount of light being emitted by the light emitting device;
store the current lighting condition parameters and the current amount of light being emitted by the light emitting device as a second set of parameters; and
till the second set of parameters for adjusting the amount of light being emitted by the light emitting device to light the object when changes to the object occurs.

16-17. (canceled)

18. The apparatus of claim 15, wherein the instructions further cause the processor to:
responsive to the user manually adjusting the amount of light being emitted by the light emitting device after the second set of parameters have been utilized to adjust the amount of light being emitted by the light emitting device, identify current lighting condition parameters and the current amount of tight being emitted by the light emitting device;
update the current lighting condition parameters and the current amount of light being emitted the light emitting device of the second set of parameters; and
utilize the second set of parameters to adjust the amount of light being emitted by the light emitting device to light the object when further changes to the object occurs.

19. The apparatus of claim 15, wherein the task-lighting device comprises a plurality of light emitting devices and where each of the light emitting device is controlled individually based on the lighting condition parameters associated with the object and wherein at least one of the light emitting devices is adjusted to output a different amount of light than at least one other of the light emitting devices.

20. The apparatus of claim 15, wherein the instructions further cause the processor to:
responsive to a failure to detect a change in the object from a first time period to a second time period, adjust the amount of light being emitted by the light emitting device to an off level; and
responsive to detecting a change in the object from the first time period to the second time period, either increase or decrease the amount of light being emitted by the light emitting device.
